(19) United States
(12) Patent Application Publication
(10) Pub. No.: US 2025/0111497 A1
(43) Pub. Date: Apr. 3, 2025

(54) Component authentication using x-ray detectable unique features

(71) Applicant: Guilherme Cardoso, Carlsbad, CA (US)

(72) Inventor: Guilherme Cardoso, Carlsbad, CA (US)

(21) Appl. No.: 18/906,088

(22) Filed: Oct. 3, 2024

Related U.S. Application Data
(60) Provisional application No. 63/542,224, filed on Oct. 3, 2023.

(51) Int. Cl. G06T 7/00; G01N 23/04

(52) U.S. Cl. CPC G06T 7/001; G01N 23/04; G01N 2223/6113; G06T 2207/10116; G06T 2207/30141

(57) ABSTRACT

A method for authenticating components by use of x-rays can include first verifying the component is authentic at a first location, scanning said component using a first x-ray scanner to obtain a first image, scrutinizing the first image for a unique feature and associating said unique feature with a feature type and a position. A record of the component in a database can be updated to contain the first image, the feature type and the feature position. The component can then be transported from the first location to a second location. At the second location the component can be rescanned using a second x-ray scanner, to create a second image, which can be scrutinized for features in common with the first feature to form a determination of authenticity.

### PRIOR APPLICATIONS

This application claims the benefit of U.S. Provisional Patent Application Ser. No. 63/542,224, filed 2023 Oct. 3, incorporated herein by reference.

### FIELD OF THE INVENTION

The instant invention relates to x-ray inspection, authentication, and more particularly to authentication using unique features on one of a group of objects.

### BACKGROUND OF THE INVENTION

Taggants have been widely adopted in the fight against counterfeit objects such as electronic components. The process of applying taggants to components includes first determining the authenticity of the part. This step can be achieved by either knowing that the component is authentic (by a well-documented chain of custody from the original component manufacturer), or by running a batch of tests to sufficiently determine the conformity of the component to its original specifications.

Taggants are often chemical compounds with a unique mix of elements that are embedded into the surface of the component. This unique mix effectively introduces a type of “fingerprint” to the component, and the combination of component identification and fingerprint is carefully uploaded to a database. Later in the supply chain, the taggant can be read back by special sensors to verify that the component and the attached fingerprint match as in the database. Some of the shortcomings of this method include the need to prepare this unique compound, the need to correctly apply it to the surface of the component, and the need to use expensive sensors to read back the fingerprint of the component at the point of use. There is also the risk that the taggant might end up in the wrong hands, which would allow such individuals to criminally authenticate counterfeit components.

Another major shortcoming of taggants relates to the authenticity protection of printed circuit board assemblies (PCBA). PCBAs can be considered electronic systems, each with hundreds or thousands of electronic components. Thus, the application of a unique taggant to each component is not economically feasible.

Automated visual inspection systems have been used for decades to determine the quality of electronic components such as populated PCBAs. For example, Vilella, U.S. Pat. No. 6,681,038 describes a parameter based automated visual scanning system. However, visual inspection, which uses photons in the visible spectrum, cannot see inside objects because the wavelength of visible photons does not allow them to penetrate through the matter of the object.

X-rays are a powerful tool in the quality assessment of objects because of the penetrating properties of the x-ray photon. This inspection modality, also called x-ray inspection, allows the imaging of the internal construction of objects such as PCBAs. As a result, x-ray inspection is a quality assessment modality often used in a wide range of industrial and commercial applications as a means to assess whether the object was manufactured within its required tolerances.

The instant invention results from efforts to provide an improved component authentication system which addresses one or more of the above problems.

### SUMMARY

The primary and secondary objects of the invention are to provide an improved item authenticity system. These and other objects are achieved by providing an x-ray based imaging and analysis system which identifies and characterizes unique features on one of a group of objects of a similar type.

In some embodiments there is provided a method for confirming the authenticity of an electronic component, said method comprising: verifying said component is authentic; scanning said component using a first x-ray scanner to obtain a first image; wherein said scanning occurs at a first geographical location; first scrutinizing said first image for a first unique feature; associating said first unique feature with a first feature type and a first feature position; updating a record of said component in a database to contain said first image, said first feature type and said first feature position; transporting said component from said first geographical location to a second geographical location a distance apart from said first geographic location; rescanning said component using a second x-ray scanner to obtain a second image; wherein said rescanning occurs at said second geographical location; second scrutinizing said second image for a second feature of the same type and location as said first unique feature; comparing said second feature with said first unique feature to form a comparison; and, determining an authentication status from said comparison.

In some embodiments said first scrutinizing comprises: selecting said first unique feature from a list of feature types.

In some embodiments said list of feature types comprises a component feature selected from the group consisting of: solder voids, bonding layer voids, unintended open circuit structures, unintended short circuit structures, solder bridges, surface mount device solder insufficiency, surface mount device solder overabundance, solder located in through hole vias, through hole solder insufficiency, through hole solder overabundance, solder residue structures, disuniform solder bumps, device to printed circuit board misalignments, small outline integrated circuit (SOIC) misalignments, quad flat no-lead package (QFN) misalignments, ball grid array (BGA) opens, BGA shorts, BGA head-in-pillow structures, BGA misalignments, wire bond misalignments, wire bond opens, wire bond shorts, and assembled printed circuit board defects.

In some embodiments the method further comprises: using a human operator to conduct said first scrutinizing.

In some embodiments the method further comprises: using an automated image processing routine to conduct said first scrutinizing.

In some embodiments said first scrutinizing comprises: calculating a number characteristic values from said first unique feature.

In some embodiments there is provided a system for confirming the authenticity of an electronic component, said system comprising: an authenticated component; a first x-ray scanner at a first geographical location; a first x-ray image of said component taken by said first x-ray scanner while said component is located at said first geographical location; a database containing a record of said component; wherein said record includes said first x-ray image; wherein said database is accessible from said first geographical location and from a second geographical location separated from said first geographical location; a second x-ray scanner at said second geographical location; a second x-ray image of said component taken by said second x-ray scanner while said component is located at said second geographical location; an image analysis subsystem connected to said database which provides for contemporaneous comparison of said first and second x-ray images, whereby a determination of authenticity came be made as a result of said comparison.

In some embodiments said image analysis subsystem comprises: a list of feature types, wherein one of said feature types is selected from the group consisting of: selected from the group consisting of: solder voids, bonding layer voids, unintended open circuit structures, unintended short circuit structures, solder bridges, surface mount device solder insufficiency, surface mount device solder overabundance, solder located in through hole vias, through hole solder insufficiency, through hole solder overabundance, solder residue structures, disuniform solder bumps, device to printed circuit board misalignments, small outline integrated circuit (SOIC) misalignments, quad flat no-lead package (QFN) misalignments, ball grid array (BGA) opens, BGA shorts, BGA head-in-pillow structures, BGA misalignments, wire bond misalignments, wire bond opens, wire bond shorts, and assembled printed circuit board defects.

In some embodiments there is provided a method for authenticating an x-ray penetrable item, said method comprising: obtaining a first x-ray image showing the internal structure of said item; first scrutinizing said first x-ray image for a first unique feature; associating said first unique feature with a first feature type and a first position; updating a record of said item in a database to contain said first image, said first feature type and said first feature position; transporting said component from said first geographical location to a second geographical location; obtaining a second x-ray image showing the internal structure of said item at said second geographical location; second scrutinizing said second image for a second feature of the same type and location as said first feature; comparing said second feature with said first unique feature to form a comparison; and, determining an authentication status from said comparison.

The content of the original claims is incorporated herein by reference as summarizing features in one or more exemplary embodiments.

### BRIEF DESCRIPTION OF THE DRAWINGS

FIG. 1 is a diagrammatical perspective illustration of a preassembled electronic component including an electronic package to be solder bonded upon a printed circuit board.

FIG. 2 is a diagrammatical partial cross-sectional side view of the package surface mounted upon the printed circuit board.

FIG. 3 is a diagrammatical partial cross-sectional top view of the bonding layer between the pad and paddle of the component of FIG. 2 showing bonding voids.

FIG. 4 is a diagrammatical side view of an x-ray scanning device used to generate an x-ray image of the internal structures of the electrical component.

FIG. 5 is a more detailed diagrammatical partial cross-sectional zoomed-in top view of the x-ray image of FIG. 4.

FIG. 6 is a diagrammatical top view of the bonding material layer between the pad and paddle of the component showing the shape and location detail of the plurality of voids.

FIG. 7 is an illustrative block diagram of a system and method to authenticate a component using a pair of an x-ray scanning devices according to an exemplary embodiment of the invention.

FIG. 8 is a diagrammatical top view of a technique to automatically characterize a void in the bonding material layer.

FIG. 9 is a flow chart diagram of a method for authenticating a component by use of an x-ray scanning device according to an exemplary embodiment of the invention.

### DESCRIPTION OF THE EXEMPLARY EMBODIMENTS

In this specification, the references to top, bottom, upward, downward, upper, lower, vertical, horizontal, sideways, lateral, back, front, proximal, distal, etc. can be used to provide a clear frame of reference for the various structures when the component is oriented upright on a printed circuit board oriented perpendicular to the force of Earth's gravity, or an image is displayed on the vertical surface of a monitor, and not treated as absolutes when the frame of reference is changed, or when the circuit board or image is oriented differently.

If used in this specification, the term “substantially” can be used because manufacturing and assembly imprecision and inaccuracies can lead to non-symmetricity and other inexactitudes in the shape, dimensioning and orientation of various structures. Further, use of “substantially” in connection with certain geometrical shapes, such as “triangular”, “wedge-shaped” and “cylindrical”, and orientations, such as “parallel” and “perpendicular”, can be given as a guide to generally describe the function of various structures, and to allow for slight departures from exact mathematical geometrical shapes and orientations, while providing adequately similar function. Those skilled in the art will readily appreciate the degree to which a departure can be made from the mathematically exact geometrical references.

If used in this specification, the word “axial” is meant to refer to directions, movement, or forces acting substantially parallel with or along a respective axis, and not to refer to rotational nor radial nor angular directions, movement or forces, nor torsional forces.

In this specification the units “millimeter” or “millimeters” can be abbreviated “mm”, “centimeter” or “centimeters” can be abbreviated “cm”, and “milligram” or “milligrams” can be abbreviated “mg”. Units of temperature such as “degrees centigrade” can be abbreviated “° C.”.

The following description will describe the exemplary embodiments primarily in connection with the authenticity assessment of an electronic component such as a populated assemble printed circuit board. However, those skilled in the art of parts manufacturing will readily appreciate the applicability of the embodiments to other electronic components, consumer products, electro-mechanical devices, and other various types of portable, x-ray penetrable articles of manufacture, that require authentication as part of the manufacturing or distribution process.

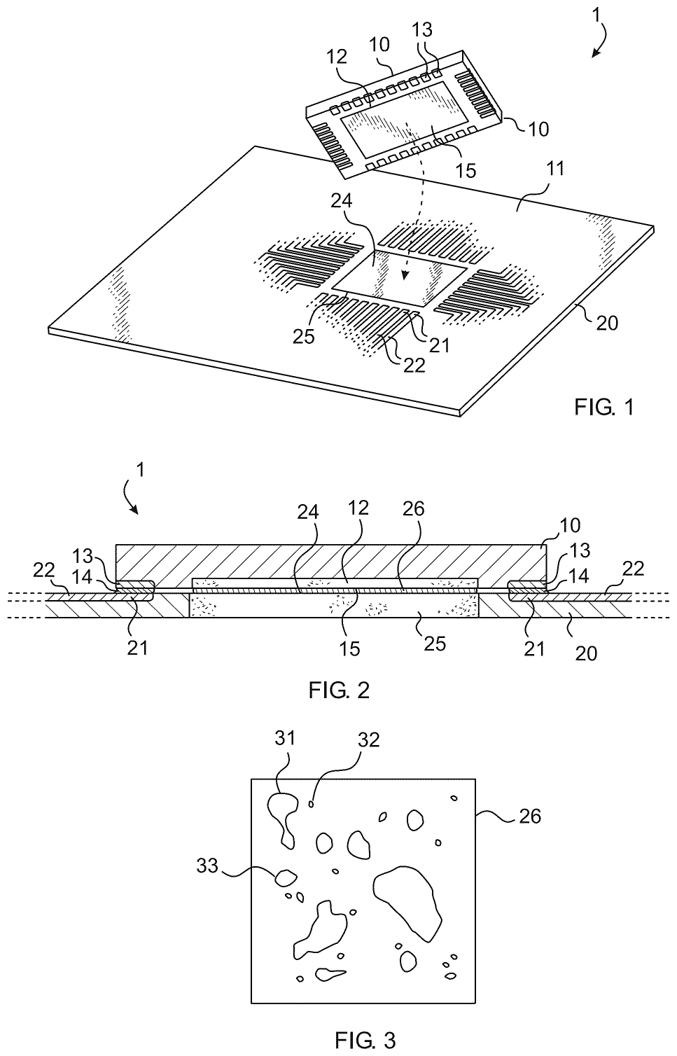

Referring now to the drawing, there is illustrated in FIGS. 1-3 an electronic component 1 including an electronic package 10 such as a quad flat no-lead package (QFN) to be solder bonded upon a printed circuit board (PCB) 20 in a surface mount technology (SMT) manner. The package can be of the bottom terminated component (BTC) type that encapsulates and protects an internal integrated circuit chip or die (not shown) mounted upon a thermally conductive metallic bottom die attach paddle 12. The die can be electrically connected to a number of electrically conductive perimeter terminals 13 spaced apart around the bottom periphery of the package. Each terminal can be electrically connected to a corresponding electrically conductive pad 21 on the upper surface 11 of the PCB using an amount of electrically conductive solder 14. Each pad can electrically connect to other electronic devices on or off the PCB via electrically conductive traces 22 embedded in the PCB.

The thermally conductive die attach paddle 12 can have a relatively broad and substantially planar undersurface 15 that can be bonded to the substantially planar upper surface 24 of a corresponding thermally conductive metallic pad 25 on the PCB 20. The bond can be formed by a layer 26 of thermally conductive package attach material such as solder, thermal grease, or other material which forms a thermal pathway from the paddle to the pad. Those skilled in the art will recognize that in the drawing, the thickness of the material layer has been greatly exaggerated for clarity.

As shown primarily in FIG. 3, typically, the bonding material layer 26 between the interfacing paddle and pad surfaces 15,24 may not completely cover those surfaces, but rather can include a number of voids 31, 32, 33 where the bonding material is absent or otherwise not uniform. Because the existence of these voids can degrade the effectiveness of the thermal dissipation of the assembled component, efforts have been made to minimize their size and number. However, many electronic components exhibit such voids to varying degrees.

The formation of voids 31, 32, 33 between the interfacing surfaces of paddle 12 and pad 25 in an assembled electronic component can result from a number of causes during manufacture such as a lack of flatness of the interfacing surfaces, lack of uniformity of the attach material, and other causes. It has been found that the size, shape, orientation, and distribution of the voids is distinctive between components. In other words, these characteristics of the voids on any given component are unique. Thus, the component can often be identified by these characteristics. And, it is highly unlikely two separate components would have a set of voids exhibiting the same characteristics.

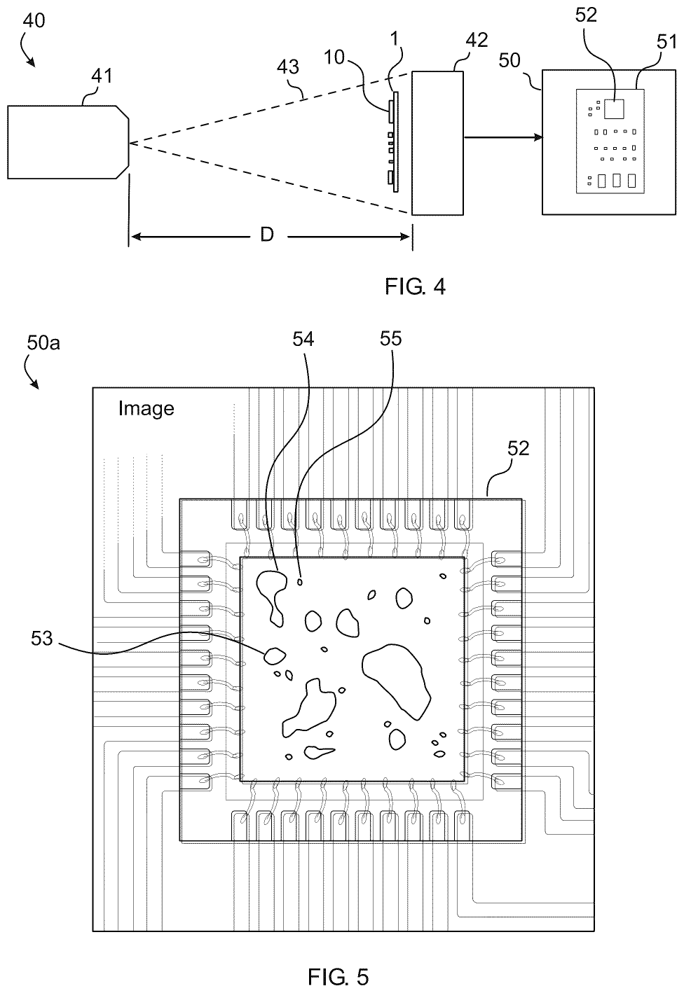

As shown in FIG. 4, an electronic component 1 in the form of an assembled electronic printed circuit board including the surface mounted electronic package 10 can be placed in an x-ray scanning device 40 so that an x-ray image 50 can be generated. The x-ray scanning device can be comprised of an x-ray source 41 and an x-ray sensor 42 which can be positioned a distance D away from the x-ray source and oriented in such a way as to receive a beam 43 of x-rays generated from the x-ray source that pass through the component. The image 50 can include a representation 51 of the internal structure of the electronic component that includes a representation 52 of bonding material layer between the pad and paddle.

FIG. 5 shows that a portion 50a of the image can show the representation 52 of bonding material layer between the pad and paddle and representations 53,54,55 of some of the voids formed between the package paddle and the PCB pad.

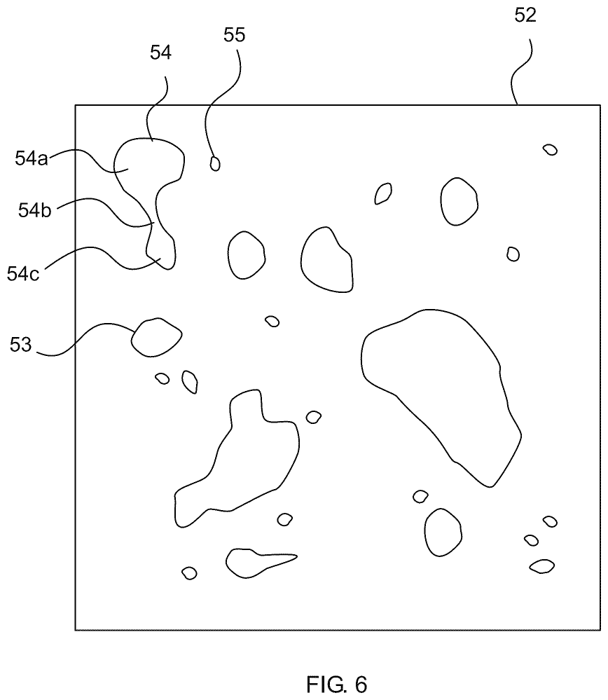

FIG. 6 shows that the representations of the voids 53,54,55 in the image can exhibit a number of characteristics that may be unique to the component with respect to other similarly manufactured components. For example, a first void representation 53 located near the top left corner of the representation of the bonding material layer 52, and can have a shape which can include a primary rounded island shape 54a joined to an elongated southern peninsula 54c by a narrowed isthmus 54b. A second void representation 53 can have a rounded onion shape on its side, while a third smaller void representation 55 can have a substantially elliptical shape. The location of each of the void representations on the image can be a characteristic used for authentication purposes. Various other identifying features such as solder cracks, part alignment, die attach porosity and voiding, die placement and alignment, and wire bonding geometry can also be used as characteristics for authentication purposes. For example, if the component uses solder balls the outline of the reflowed solder for each ball can have a specific size, diameter, and eccentricity. Such measurements cannot currently be reproduced in a manufacturing process, especially if something has changed on the board. Indeed, the way solder melts and then solidifies on a components is stochastic by nature.

Thus, many other types of electronic component features and their individual characteristics can be used as possible unique features for authentication purposes. For example, a list of feature types can include solder voids, bonding layer voids, unintended open circuit structures, unintended short circuit structures, solder bridges, surface mount device solder insufficiency, surface mount device solder overabundance, solder located in through hole vias, through hole solder insufficiency, through hole solder overabundance, solder residue structures, disuniform solder bumps, device to printed circuit board misalignments, small outline integrated circuit (SOIC) misalignments, quad flat no-lead package (QFN) misalignments, ball grid array (BGA) opens, BGA shorts, BGA head-in-pillow structures, BGA misalignments, wire bond misalignments, wire bond opens, wire bond shorts, and assembled printed circuit board defects. The operator or an automated feature recognition system can run through the list sequentially to identify candidate features.

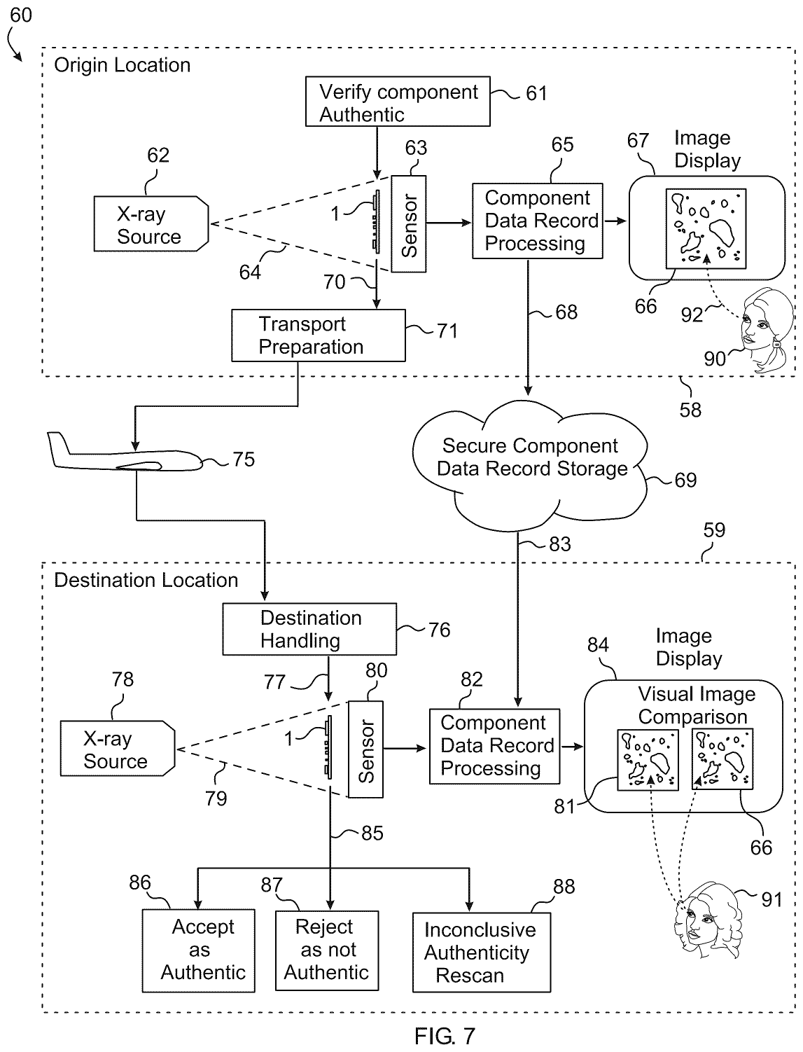

Referring now to FIG. 7, there is shown a system and method 60 for verifying the authenticity of one of a plural number of similar x-ray penetrable objects such as an electronic component 1. First, the component's authenticity is verified 61 based on receipt from the manufacturer. At the origin location 58 the component can be scanned using an x-ray scanner having an x-ray source 62 which generates a beam 64 of x-rays penetrating the component. An x-ray sensor 63 can capture the x-rays passing through the component to form an image representing the component. The image 66 can be processed by a component data record processing unit 65 and displayed on a display 67 so that an operator 90 can observe 92 it to verify whether the image is of an adequate quality for authentication purposes. If not, the operator can initiate a rescan making optional adjustments to the scanning parameters such as scanner power. The component data record including the image can then be uploaded 68 to a data record storage unit 69 on a secure network connected to the scanner at the origin location.

It shall be understood that the component data record processing unit 65 can be programmed to automatically identify various unique identifying features of the electronic component 1 such as those previously described to use for authentication purposes. After identification of the unique identification features, the component data record processing unit can update a computerized data record assigned to the component with data encompassing the types of features, their locations, and any other characterizing attributes of each feature. The component data record processing unit can then transmit 68 the updated record to a secure component data record storage unit 69. Alternatively, an operator 90 can scrutinize 92 the first x-ray image 66 on the image display 67 and manually select various unique identifying features of the electronic component such as those previously described to use for authentication purposes and enter those into the database record for the component. The secure component data record storage unit can be any previously known solutions such as secure cloud storage or other secure databases.

After the electronic component 1 has been scanned, it can then be ejected 70 from the scanner and packaged or otherwise prepared 71 for transport to a destination location. Preparation can include any number of distribution subsystems such as packaging and handling the item by hand, or automated item handling. The electronic component can then be transported 75 from the origin location 58 to a destination location 59.

Once the electronic component 1 has reached the destination location 59, the component is handled 76 such as by removing it from its packaging and otherwise preparing it for a second x-ray scan at the destination location. The component can be placed 77 into a second x-ray scanner having an x-ray source 78 generating a beam 79 of x-rays to pass through the component and be detected by an x-ray sensor 80 to form a second x-ray image representing the component. The second x-ray image 81 is transmitted to a second component data record processing unit 82 which can download 83 the record for the component from the secure component data record storage database 69.

The component data record can include the first x-ray image 66 and other data relating to the component including potentially data encompassing the types of identifying features, their locations, and any other characterizing attributes of each of those features. The first and second images 66,81 can be displayed on a display 84 for an operator to compare visually. In this way the display 84 and operator 91 can act as an image analysis subsystem connected to the component data record database 69 to provide contemporaneous comparison of the first and second x-ray images 66,81, whereby a determination of authenticity came be made as a result of the comparison.

Alternately, the second component data record processing unit 82 can perform an automated comparison of the first and second x-ray images and any other data recorded or generated based on those images. The result of that comparison will cause the component to be either accepted as authentic 86, rejected as non-authentic 87, or needing to be rescanned 88 because the current scans were inconclusive as to authenticity.

It shall be understood that the function of many of the functional units of the system can be carried out by processing routines running on other computer(s) connected to the network. For example, component data processing 65,82 can be accomplished by a separate computer having access to the secure data record storage unit 69. Those skilled in the data processing arts will readily appreciate the various functional variations available.

Although a comparison can be made by a human operator, such comparisons can be tedious, prone to error and thus expensive. Consequently, an automated comparison can be made using various image processing software algorithms well-known in the art. These can include so-called golden board type analysis using machine learning algorithms or other measurements.

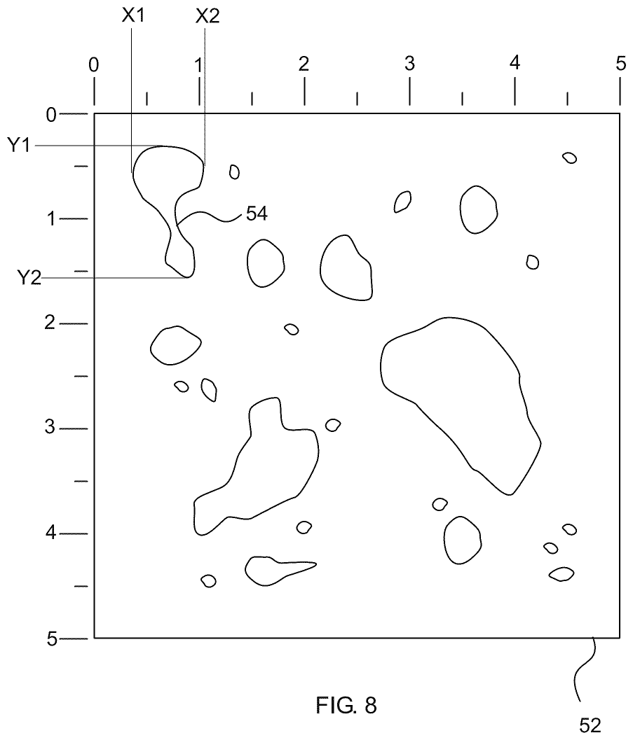

For example, as shown in FIG. 8, there is shown the portion of the x-ray image 52 showing the representation of the voids formed between the pad 25 and paddle 12 of the component 1. The image can be divided into a cartesian-like grid having an origin at coordinates 0,0 in the upper left corner. The image can be scrutinized successively from the origin in ever increasing coordinates until a change in color and/or brightness beyond a threshold level is discovered. This can occur at the first void 54. Once the void has been found its characteristics can be determined from standard image analysis techniques. They can include, but are not limited to, determining left and right most extents X1,X2 of the void on the x-axis, and top and bottom most extents Y1, Y2 of the void on the y-axis. From the drawing, by way of example, a value for X1 can be 0.6, and a value for X2 can be 1.1. These values as well as those for the y-axis extents can be recorded as parameters in the component record. Values of other characteristics such as the area, center location, etc. can be calculated or measured. Values can be similarly calculated for the other detectable voids in the image and similarly stored in the data record. Because of the uniqueness and reproducability of these values from the second scanned image of the component, the authenticity of the component can be verified at the destination.

It is important to note that normal usage of the component, even under thermal cycling, humidity and altitude variations, will not change the unique features identified to create the first x-ray image of the component. However, reworking the parts containing the unique features could cause a mismatch when the first x-ray image is compared to the second x-ray image. This is an added advantage of the x-ray image technique over taggants because unlike taggants, the unique features identified in the first x-ray image can identify illicit reworked parts in the second x-ray image.

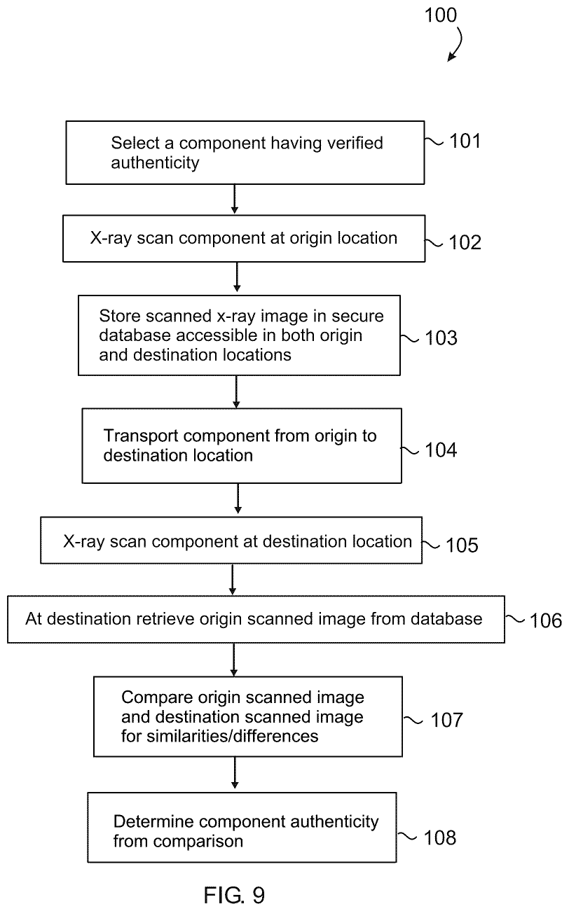

FIG. 9 shows an embodiment 100 of the primary steps which can be used to authenticate a component according to the claimed invention. First, a component that has been previously verified as authentic can be selected 101. Next, the selected component can be scanned by an x-ray scanning device, as previously described, at an origin location 102. Next, the image generated by the previously described x-ray scanning device can be stored in a secure image database that is accessible from both the origin destination and a destination location 103. The selected component can then be transported from the origin location to a destination location 104. At the destination location, the selected component can again be scanned by an x-ray scanning device 105. After the component has been scanned, the scanned image from the origin location can be retrieved from the secure database 106. The origin image and the destination image can then be compared for differences 107. Finally, the authenticity of the component can be determined based on the comparison of the origin image and the destination image 108.

In this way the x-ray image can be used as a unique fingerprint for an electronic component or PCBA. Various unique features of the x-ray can be used in tandem to create a unique fingerprint for a single component or an entire PCBA. This technique can also be expanded to mechanical objects by utilizing other idiosyncratic features of the part-such as voids and porosity-to generate the x-ray image fingerprint.

The x-ray image fingerprint can be calculated using well-known image processing algorithms to generate a number of numerical feature characteristics. These characteristic values can be inserted along with the image itself into a database record for the item being authenticated. Unlike taggants, the x-ray image technique does not allow for any adulteration because material is not being added to the item. Instead, the x-ray image fingerprint technique uses features of the item itself to generate the fingerprint parts.

Later in the supply chain, to read back these features to verify the authenticity of the item such as an electronic component or PCBA, the user needs only to image the item again using a compatible x-ray machine. The identification of the item will determine which locations and features are to be used to retrieve the fingerprint from the database. The same algorithms can then be used to determine if any changes have occurred to the item, and if the item is the same as the one originally introduced in the database.

While the preferred embodiment of the invention has been described, modifications can be made and other embodiments may be devised without departing from the spirit of the invention and the scope of the appended claims.

1. A method for confirming the authenticity of an electronic component, the method comprising:
verifying the component is authentic;
scanning the component using a first x-ray scanner to obtain a first image;
wherein the scanning occurs at a first geographical location;
first scrutinizing the first image for a first unique feature;
associating the first unique feature with a first feature type and a first feature position;
updating a record of the component in a database to contain the first image, the first feature type and the first feature position;
transporting said component from the first geographical location to a second geographical location a distance apart from the first geographic location;
rescanning the component using a second x-ray scanner to obtain a second image;
wherein the rescanning occurs at the second geographical location;
second scrutinizing the second image for a second feature of the same type and location as the first unique feature;
comparing the second feature with the first unique feature to form a comparison; and,
determining an authentication status from the comparison.

2. The method of claim 1, wherein the first scrutinizing comprises:
selecting the first unique feature from a list of feature types.

3. The method of claim 2, wherein the list of feature types comprises a component feature selected from the group consisting of:
solder voids, bonding layer voids, unintended open circuit structures, unintended short circuit structures, solder bridges, surface mount device solder insufficiency, surface mount device solder overabundance, solder located in through hole vias, through hole solder insufficiency, through hole solder overabundance, solder residue structures, disuniform solder bumps, device to printed circuit board misalignments, small outline integrated circuit (SOIC) misalignments, quad flat no-lead package (QFN) misalignments, ball grid array (BGA) opens, BGA shorts, BGA head-in-pillow structures, BGA misalignments, wire bond misalignments, wire bond opens, wire bond shorts, and assembled printed circuit board defects.

4. The method of claim 1, which further comprises:
using a human operator to conduct the first scrutinizing.

5. The method of claim 1, which further comprises:
using an automated image processing routine to conduct the first scrutinizing.

6. The method of claim 1, wherein the first scrutinizing comprises:
calculating a number characteristic values from the first unique feature.

7. A system for confirming the authenticity of an electronic component, the system comprising:
an authenticated component;
a first x-ray scanner at a first geographical location;
a first x-ray image of the component taken by the first x-ray scanner while the component is located at the first geographical location;
a database containing a record of the component;
wherein the record includes the first x-ray image;
wherein the database is accessible from the first geographical location and from a second geographical location separated from the first geographical location;
a second x-ray scanner at the second geographical location;
a second x-ray image of the component taken by the second x-ray scanner while the component is located at the second geographical location;
an image analysis subsystem connected to the database which provides for contemporaneous comparison of the first and second x-ray images, whereby a determination of authenticity came be made as a result of the comparison.

8. The system of claim 7, wherein the image analysis subsystem comprises:
a list of feature types, wherein one of said feature types is selected from the group consisting of:
solder voids, bonding layer voids, unintended open circuit structures, unintended short circuit structures, solder bridges, surface mount device solder insufficiency, surface mount device solder overabundance, solder located in through hole vias, through hole solder insufficiency, through hole solder overabundance, solder residue structures, disuniform solder bumps, device to printed circuit board misalignments, small outline integrated circuit (SOIC) misalignments, quad flat no-lead package (QFN) misalignments, ball grid array (BGA) opens, BGA shorts, BGA head-in-pillow structures, BGA misalignments, wire bond misalignments, wire bond opens, wire bond shorts, and assembled printed circuit board defects.

9. A method for authenticating an x-ray penetrable item, the method comprising:
obtaining a first x-ray image showing the internal structure of said item;
first scrutinizing the first x-ray image for a first unique feature;
associating the first unique feature with a first feature type and a first position;
updating a record of said item in a database to contain the first image, the first feature type and the first feature position;
transporting the component from said first geographical location to a second geographical location;
obtaining a second x-ray image showing the internal structure of the item at the second geographical location;
second scrutinizing the second image for a second feature of the same type and location as the first feature;
comparing the second feature with the first unique feature to form a comparison; and,
determining an authentication status from the comparison.
